(19) United States
(12) Patent Application Publication
(10) Pub. No.: US 2009/0245906 A1
(43) Pub. Date: Oct. 1, 2009

(54) IMAGE FORMING DEVICE AND IMAGE FORMING APPARATUS HAVING THE SAME

(75) Inventors: Yeon Taek JEONG, Suwon-si (KR); Jong In Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/366,038

(22) Filed: Feb. 5, 2009

(30) Foreign Application Priority Data
Apr. 1, 2008 (KR) 2008-30285

(51) Int. Cl. G03G 15/00; B65H 1/00

(52) U.S. Cl. 399/388; 271/145

(57) ABSTRACT

An image forming device includes a housing, a paper loading portion provided at an upper surface of the housing to load paper to be discharged and having a paper discharge hole, a fixing unit disposed in an upper region of the housing and used to fix a developer to the paper, and a cover to open or close an upper side of the fixing unit, the cover having one end protruding from the paper discharge hole.

### CROSS-REFERENCE TO RELATED APPLICATIONS

This application claims priority under 35 U.S.C. §119(a) from Korean Patent Application No. 2008-0030285, filed on Apr. 1, 2008 in the Korean Intellectual Property Office, the disclosure of which is incorporated herein in its entirety by reference.

### BACKGROUND OF THE INVENTION

1. Field of the Invention

The present general inventive concept relates to an image forming apparatus, and, more particularly, to an image forming device having a jam-removal cover, and an image forming apparatus having the same.

2. Description of the Related Art

Generally, an image forming apparatus is an apparatus to print an image on paper according to input signals. Examples of the image forming apparatus include printers, copiers, facsimiles, devices combining functions thereof, and the like.

These various types of image forming apparatuses commonly include image forming devices to form an image. The image forming device includes a housing defining an external appearance of the image forming device, a paper feeding unit to feed paper, a developing unit to develop an electrostatic latent image into a visible image, a transfer unit to transfer the visible image, developed by the developing unit, to paper, a fixing unit to fix the image on the paper by applying heat and pressure to the paper, a paper discharge unit to discharge the paper, on which the image is formed, to the outside, etc.

The above-described image forming apparatuses are generally provided, at an upper surface of the housing, with a paper loading portion in which the paper, after completion of image formation, is loaded, and the fixing unit is disposed in a rear region of the housing. As the paper, on which a developer is adhered to develop the image, vertically passes through the fixing unit, the fixing unit applies heat and pressure to the paper so as to fix the developer on the paper, completing image formation. Thereafter, the paper, after completion of image formation, is discharged through a discharge hole formed at one side of the paper loading portion, and is loaded on the paper loading portion.

Specifically, the paper passes between a heating roller and a press roller of the fixing unit in an approximately vertical direction and thereafter, is discharged through the discharge hole. A cover is disposed at a rear surface of the housing and is used to remove a paper jam caused while paper is delivered through the fixing unit.

However, when the housing is reduced in size to realize miniaturization of the image forming device, the fixing unit must be disposed close to an upper surface of the housing due to a limited interior space of the housing. Therefore, to discharge the paper, having passed through the fixing unit, through the discharge hole, rapid change of a paper delivery direction by almost 90 degrees is inevitable. This increases a likelihood of a paper jam caused above the fixing unit.

Furthermore, providing the cover at a rear surface of the housing necessitates removal of jammed paper through a narrow gap between the fixing unit and the upper surface of the housing, or to separate the fixing unit from the housing for removal of the jammed paper, resulting in a troublesome jam removal operation.

### SUMMARY OF THE INVENTION

The present general inventive concept provides an image forming apparatus to easily remove a paper jam caused above a fixing unit.

Additional aspects and/or utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an image forming device including a housing, a paper loading portion provided at an upper surface of the housing to load paper to be discharged and having a paper discharge hole, a fixing unit disposed in the housing and used to fix a developer to the paper, and a cover to open or close the upper side of the fixing unit, the cover having one end protruding from the paper discharge hole.

The paper loading portion, having the paper discharge hole formed at one side thereof, may be recessed at the upper surface of the housing, and the cover may be configured to cover the upper side of a partial region of the paper loading portion adjacent to the paper discharge hole.

A stacker may be provided at one side of the paper loading portion, to allow the paper discharged from the paper discharge hole to be easily loaded on the paper loading portion, and the end of the cover protruding from the paper discharge hole may be spaced apart from the stacker.

The stacker may be rotatably disposed at the paper loading portion, and the end of the cover protruding from the paper discharge hole may be located outside of a rotating radius of the stacker.

The device may further include an auxiliary stacker rotatably disposed at a lower surface of the cover, to guide the paper discharged from the paper discharge hole downward.

The device may further include at least one guide rib protruding from a lower surface of the cover and configured to extend lengthwise in a movement direction of the paper discharged through the paper discharge hole.

The at least one guide rib may include a plurality of guide ribs arranged to be spaced apart from one another in a width direction of the paper discharged through the paper discharge hole.

The cover may be rotatably coupled, at one end thereof, to the housing, to open or close the upper side of the fixing unit.

The device may further include an image reading unit disposed above the housing so as to be spaced apart from the upper surface of the housing, the image reading unit being used to read an image recorded on a document.

The foregoing and/or other aspects and utilities of the general inventive concept may also be achieved by providing an image forming apparatus including a paper feeding unit to feed paper, a developing unit to develop a latent image to a visible image, a transfer unit to transfer the visible image developed by the developing unit to the paper, a fixing unit to fix the developer to the paper, and a cover to cover the upper side of the fixing unit, the cover having one end protruding outward of a paper discharge hole through which the paper, after completion of image formation, is discharged.

The apparatus may further include a housing having the paper discharge hole through which the paper, after completion of image formation, is discharged, and a paper discharge unit may be disposed at the paper discharge hole, to discharge the paper through the paper discharge hole.

The paper discharge unit may include a paper guide disposed between the fixing unit and the paper discharge hole to guide the paper, having passed through the fixing unit, to the paper discharge hole, and a plurality of paper discharge rollers disposed at the paper discharge hole to discharge the paper through the paper discharge hole.

The cover may protrude from the paper discharge hole to cover the plurality of paper discharge rollers.

The apparatus may further include an image reading device spaced apart upward from the cover and used to read an image from a document.

The paper may be delivered via a C-shaped delivery path from the paper feeding unit to the discharge hole by way of the fixing unit, and the fixing unit is disposed downstream of the transfer unit to allow the paper to vertically pass through the fixing unit.

A paper loading portion, having the paper discharge hole formed at one side thereof, may be recessed at an upper surface of the housing, and the cover may be configured to cover the upper side of a partial region of the paper loading portion adjacent to the paper discharge hole.

The foregoing and/or other aspects and utilities of the general inventive concept may also be achieved by providing an image forming device including a fixing unit to fix developer to a recording medium, a housing to support a fixing unit, and including a paper loading portion to form a recess and a paper discharge hole to discharge the recording medium after the developer is fixed thereon, and a cover to removable cover a portion of the paper loading portion adjacent to the paper discharge hole.

The image forming device may include one or more guide ribs may be disposed at a lower surface of the cover to prevent the recording medium discharged through the paper discharge hole from direct contact with a lower surface of the cover.

The loading portion may include a slope to support recording media.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1 is a perspective view illustrating an image forming apparatus in accordance with an embodiment of the present general inventive concept;

FIG. 2 is a side sectional view of the image forming apparatus in accordance with the embodiment of FIG. 1;

FIG. 3 is an enlarged view of the portion III of FIG. 2; and

FIG. 4 is a perspective view illustrating an image forming apparatus in accordance with an embodiment of the present general inventive concept.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

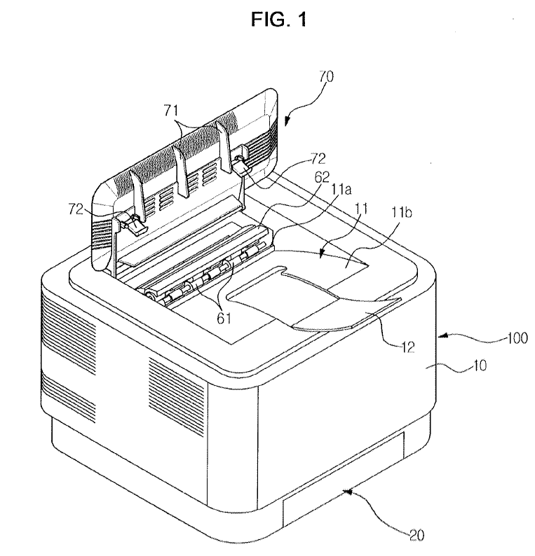

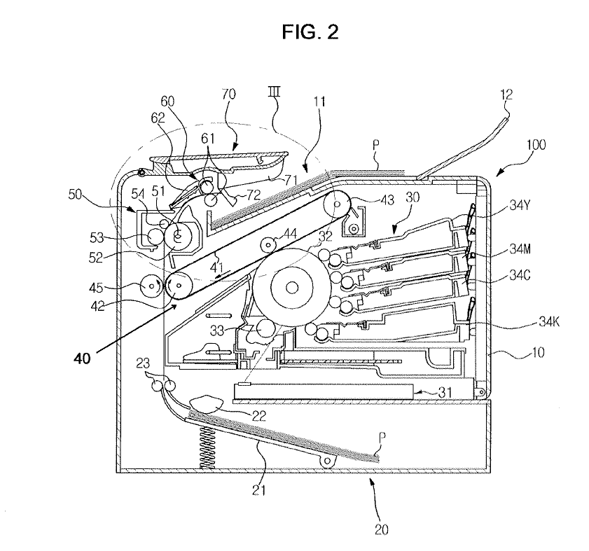

The image forming apparatus in accordance with an embodiment of the present general inventive concept, as illustrated in FIG. 1, includes an image forming device 100 to form an image. The image forming device 100 includes a housing 10, which defines an external appearance of the image forming device 100 and supports a variety of parts disposed therein. As illustrated in FIG. 2, provided in the housing 10 are a paper feeding unit 20 to feed recording media such as paper P, a developing unit 30 to develop a latent image into a visible image, a transfer unit 40 to transfer the visible image developed by the developing unit 30 to the paper P, a fixing unit 50 to fix the image on the paper P by applying heat and pressure to the paper P, and a paper discharge unit 60 to discharge the paper P, after completion of the image formation, to the outside.

The paper feeding unit 20 includes a paper feeding tray 21 in which plural sheets of paper S are loaded, a pickup roller 22 to pick up the paper P loaded in the paper feeding tray 21 sheet by sheet, and a pair of feed rollers 23 arranged in parallel to deliver the paper P through a gap therebetween.

Referring to FIG. 2, the developing unit 30 includes an exposure unit 31 which is selected from a Laser Scanning Unit (LSU), etc., and is used to irradiate a laser beam containing image information, a photosensitive member 32 which has a drum shape and is formed at a surface thereof with an electrostatic latent image by the exposure unit 31, a charge roller 33 to electrically charge the photosensitive member 32, and four developing cartridges 34Y, 34M, 34C and 34K to develop the electrostatic latent image formed on the photosensitive member 32 to a visible image via Yellow, Magenta, Cyan and Black developer. The exposure unit 31 incorporates a laser diode (not illustrated) to emit a laser beam, a polygonal mirror (not illustrated) to distribute the laser beam emitted from the laser diode, etc. As the laser beam distributed by the polygonal mirror is transmitted to the photosensitive member 32 above the exposure unit 31, the electrostatic latent image is formed on the photosensitive member 32.

The transfer unit 40 includes an intermediate transfer belt 41 to transmit the developer from the photosensitive member 32 to the paper P, a pair of drive rollers 42 and 43 disposed at opposite sides of the intermediate transfer belt 41 to rotate the intermediate transfer belt 41, a first transfer roller 44 coming into surface contact with the photosensitive member 32 with the intermediate transfer belt 41 being interposed therebetween, and a second transfer roller 45 coming into contact with the drive roller 45 with the intermediate transfer belt 41 being interposed therebetween.

The fixing unit 50 serves to fix the developer to the paper P by applying heat and pressure to the paper P. The fixing unit 50 includes a heating roller 52 in which a heater 51 is disposed to apply heat to the paper P, to which the developer is transferred, and a first press roller 53 and a second press roller 54 disposed opposite the heating roller 52 to maintain a constant fixing pressure in a gap with the heating roller 52. In the present embodiment, the fixing unit 50 is disposed downstream of the transfer unit 40, whereby the paper P vertically passes through the fixing unit 50 to achieve fixing of the developer.

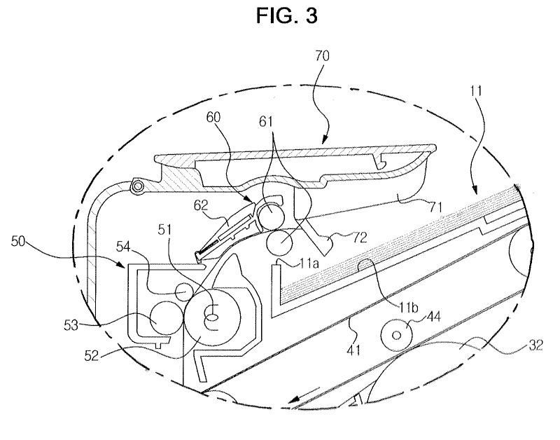

Referring to FIGS. 1 and 2, the paper discharge unit 60 includes a plurality of paper discharge rollers 61 which are disposed at a paper discharge hole 11a (FIG. 3) that will be described hereinafter and are used to discharge the paper P, having passed through the fixing unit 50, to the outside, and a paper guide 62 which is disposed between the fixing unit 50 and the discharge rollers 61 and is used to guide the paper P, having passed through the fixing unit 50, to a gap between the paper discharge rollers 61. After the paper P delivered from the paper feeding unit 20 passes through the fixing unit 50, the paper P is guided to the paper discharge hole 11a, at which the paper discharge rollers 61 are disposed, by the paper guide 62. Accordingly, the paper P is discharged through the paper discharge hole 11a by being delivered along an approximately C-shaped delivery path.

As illustrated in FIG. 3, an upper surface of the housing 10 is recessed to define a paper loading portion 11 in which the paper P, after completion of image formation and discharge from the housing 10, is loaded. The paper discharge hole 11a is formed at one side of the paper loading portion 11, to discharge the paper P, after completion of image formation. The paper loading portion 11 is provided with a slope 11b extending obliquely from the discharge hole 11a to the other side thereof, to allow the paper P to be accumulated uniformly thereon. As described above, the plurality of paper discharge rollers 61 are arranged at the paper discharge hole 11a such that they are spaced apart from one another in a width direction of the paper P which is discharged through the paper discharge hole 11a (See FIG. 1).

In the above-described image forming apparatus, when reduction in a size of the apparatus is attempted, the fixing unit 50 must be disposed close to the paper discharge hole 11a due to a limited interior space of the housing 10 as illustrated in FIG. 3. Therefore, a delivery direction of the paper P, having passed through the fixing unit 50, must be changed by a steep angle of almost 90 degrees above the fixing unit 50 and there is a risk of a paper jam easily occurring above the fixing unit 50. That is, the delivery direction of the paper P is changed to a bending direction such that the paper P passing through the fixing unit 50 is bent by the paper guide 62 in the bending direction.

Accordingly, the image forming apparatus according to the present embodiment is provided, at one side of the upper surface of the housing 10, with a jam-removal cover 70 to easily remove a paper jam caused above the fixing unit 50. The jam-removal cover 70 is configured to open or close the upper side of the fixing unit 50 disposed within the housing 10.

Also, when the fixing unit 50 is disposed close to the paper discharge hole 11a, heat generated from the fixing unit 50 is transmitted to the paper discharge hole 11a. Therefore, when the user grips the cover 70 to remove a paper jam, there is a risk of the user's hand contacting the paper discharge hole 11a, possibly resulting in injury. Furthermore, exterior impurities are introduced into the fixing unit 50 through a space between the paper discharge rollers 61 that are spaced apart from each other in a width direction of the paper P, causing problems in the fixing unit 50 due to impurities. That is, the impurities are adhered to a surface of the heating roller of the fixing unit, causing a paper jam in a course of the developer being fixed to the paper.

To solve the above-described problems, the jam-removal cover 70 is configured such that the cover 70 protrudes from the paper discharge hole 11a so as to cover a partial upper region of the slope 11b. Specifically, the cover 70 is configured to open or close a partial region of the upper surface of the housing 10 and simultaneously, to cover the partial upper region of the slope 11b of the paper loading portion 11.

In a state wherein one end of the cover 70 protrudes from the paper discharge hole 11a to cover the partial upper region of the slope 11b, the paper discharge hole 11a is covered by the end of the protruding cover 70 to limit the user's hand from accessing the discharge hole 11a. Therefore, preventing accidents that may be caused by heat transmitted from the fixing unit 50 to the paper discharge hole 11a when the size of the image forming apparatus is reduced is possible. Also, entrance of impurities into the discharge hole 11a is impeded and therefore, preventing problems caused by introduction of impurities into the fixing unit 50 through the paper discharge hole 11a is possible. In addition, even if the paper P is jammed in the housing 10, the user can easily grip and pull the cover 70 protruding upward from the slope 11b, whereby opening/closing operations of the cover 70 can be more easily implemented.

It is possible that the other partial region of the paper loading portion 11 is not covered by the cover 70 as illustrated in FIGS. 2 and 3. Therefore, the cover 70 covers a portion of the discharged paper P, and the other portion of the discharged paper P is exposed to an outside of a space formed between the cover 70 and the paper loading portion 11.

Guide ribs 71 protrude downward from a lower surface of the cover 70, to guide the paper P discharged through the paper discharge hole 11a. The guide ribs 71 extend lengthwise in a movement direction of the paper P discharged through the paper discharge hole 11a, to guide movement of the paper P. As illustrated in FIG. 1, the plurality of guide ribs 71 are arranged to be spaced apart from one another in a width direction of the paper P discharged through the paper discharge hole 11a.

Providing the plurality of guide ribs 71 at a lower surface of the cover 70 can prevent the paper P discharged through the paper discharge hole 11a from coming into direct contact with the lower surface of the cover 70 and consequently, prevent heat of the paper P, heated while passing through the fixing unit 50, from being directly transmitted to the cover 70. As a result, the user can safely grip the cover 70, and the user's hand is prevented from entering a space between the guide ribs 71 and the slope 11b of the paper loading portion 11. Further, the plurality of guide ribs 71 are spaced apart from one another, assuring smooth passage of air through spaces therebetween. Therefore, heat of the paper P, heated while passing through the fixing unit 50, can be easily emitted to the outside through the spaces between the guide ribs 71.

In the present embodiment, an other side of the paper loading portion 11, namely, the other side of the slope 11b, except for the partial region of the slope 11b covered by the end of the cover 70, is provided with a stacker 12, to allow the paper P, after completion of image formation, to be more stably loaded on the paper loading portion 11. An auxiliary stacker 72 is rotatably disposed at the lower surface of the cover 70, to allow the paper P, discharged from the paper discharge hole 11a, to be more stably loaded on the slope 11b below the auxiliary stacker 72 as the auxiliary stacker 72 is rotated.

The end of the cover 70 protruding from the paper discharge hole 11a is spaced apart from the stacker 12. In the present embodiment, the stacker 12 is rotatably coupled to the other side of the slope 11b, such that the stacker 12 may be disposed on the slope 11b by rotation thereof or may be separated from the slope 11b so as to protrude obliquely forward and upward of the slope 11b. Therefore, the cover 70 is configured to have a predetermined length such that one end thereof, protruding from the paper discharge hole 11a, can be positioned outside of a rotating radius of the stacker 12, to prevent rotation of the stacker 12 from being impeded by the cover 70. The cover 70 is disposed between the image reading device 200 and the image forming device 100 to be moveable in a space formed therebetween.

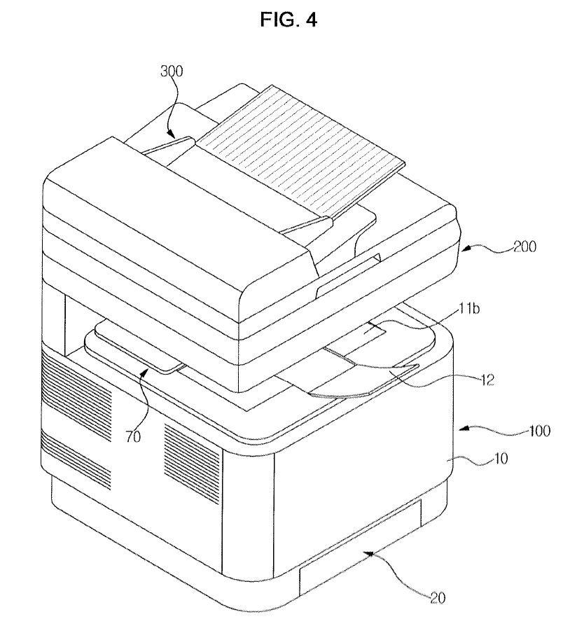

Although the present embodiment discloses the image forming apparatus including only the image forming device 100 by way of example, the present general inventive concept is not limited thereto. For example, according to an embodiment as illustrated in FIG. 4, the present general inventive concept is applicable to an image forming apparatus which includes the image forming device 100 to form an image, an image reading device 200 to read an image from a document, and an automatic document feeding unit 300 to automatically feed the document so as to allow the image reading device 200 to continuously read the document.

As apparent from the above description, various embodiments of the present general inventive concept provide an image forming device and an image forming apparatus having the same, wherein a cover is disposed above a fixing unit, enabling easy removal of a paper jam caused above the fixing unit.

Further, in the image forming apparatus according to various embodiments of the present general inventive concept, the cover protrudes from a paper discharge hole, impeding access of the user's hand to the discharge hole. Therefore, preventing the user's hand from being burned even if heat of the fixing unit is transmitted to the paper discharge hole due to a short distance between the fixing unit and the paper discharge hole is possible.

Furthermore, the paper discharge hole is covered by one end of the cover protruding from the paper discharge hole, efficiently preventing impurities from entering the fixing unit through the paper discharge hole.

Although embodiments of the present general inventive concept have been illustrated and described, it would be appreciated by those skilled in the art that changes may be made in this embodiment without departing from the principles and spirit of the general inventive concept, the scope of which is defined in the claims and their equivalents.

What is claimed is:

1. An image forming device, comprising:
a housing;
a paper loading portion provided at an upper surface of the housing to load paper to be discharged and having a paper discharge hole;
a fixing unit disposed in the housing and used to fix a developer to the paper; and
a cover to open or close an upper side of the fixing unit, the cover having one end protruding from the paper discharge hole.

2. The device according to claim 1, wherein the paper loading portion, having the paper discharge hole formed at one side thereof, is recessed at an upper surface of the housing, and the cover is configured to cover the upper side of a partial region of the paper loading portion adjacent to the paper discharge hole.

3. The device according to claim 1, wherein a stacker is provided at one side of the paper loading portion, to allow the paper discharged from the paper discharge hole to be loaded on the paper loading portion, and the end of the cover protruding from the paper discharge hole is spaced apart from the stacker.

4. The device according to claim 3, wherein the stacker is rotatably disposed at the paper loading portion, and the end of the cover protruding from the paper discharge hole is located outside of a rotating radius of the stacker.

5. The device according to claim 1, further comprising:
an auxiliary stacker rotatably disposed at a lower surface of the cover, to guide the paper discharged from the paper discharge hole downward.

6. The device according to claim 1, further comprising:
at least one guide rib protruding from a lower surface of the cover and configured to extend lengthwise in a movement direction of the paper discharged through the paper discharge hole.

7. The device according to claim 6, wherein the at least one guide rib comprises:
a plurality of guide ribs arranged to be spaced apart from one another in a width direction of the paper discharged through the paper discharge hole.

8. The device according to claim 1, wherein the cover is rotatably coupled, at one end thereof, to the housing, to open or close the upper side of the fixing unit.

9. The device according to claim 1, further comprising: an image reading unit disposed above the housing so as to be spaced apart from the upper surface of the housing, the image reading unit being used to read an image recorded on a document.

10. An image forming apparatus, comprising:
a paper feeding unit to feed paper;
a developing unit to develop a latent image into a visible image;
a transfer unit to transfer the visible image developed by the developing unit to the paper;
a fixing unit to fix the developer to the paper; and
a cover to cover an upper side of the fixing unit, the cover having one end protruding outward of a paper discharge hole through which the paper, after completion of image formation, is discharged.

11. The apparatus according to claim 10, further comprising:
a housing having the paper discharge hole through which the paper, after completion of image formation, is discharged,
wherein a paper discharge unit is disposed at the paper discharge hole, to discharge the paper through the paper discharge hole.

12. The apparatus according to claim 11, wherein the paper discharge unit includes a paper guide disposed between the fixing unit and the paper discharge hole to guide the paper, having passed through the fixing unit, to the paper discharge hole, and a plurality of paper discharge rollers disposed at the paper discharge hole to discharge the paper through the paper discharge hole, and the cover protrudes from the paper discharge hole to cover the plurality of paper discharge rollers.

13. The apparatus according to claim 10, further comprising:
an image reading device spaced apart upward from the cover and used to read an image from a document.

14. The apparatus according to claim 10, wherein the paper is delivered via a C-shaped delivery path from the paper feeding unit to the discharge hole by way of the fixing unit, and the fixing unit is disposed downstream of the transfer unit to allow the paper to vertically pass through the fixing unit.

15. The apparatus according to claim 10, wherein a paper loading portion, having the paper discharge hole formed at one side thereof, is recessed at an upper surface of the housing, and the cover is configured to cover the upper side of a partial region of the paper loading portion adjacent to the paper discharge hole.

16. The apparatus according to claim 10, wherein a stacker is provided at one side of a paper loading portion, to allow the paper discharged from the paper discharge hole to be easily loaded on the paper loading portion, and the end of the cover protruding from the paper discharge hole is spaced apart from the stacker.

17. The apparatus according to claim 16, wherein the stacker is rotatably disposed at the paper loading portion, and the end of the cover protruding from the paper discharge hole is located outside of a rotating radius of the stacker.

18. The apparatus according to claim 10, further comprising:
an auxiliary stacker rotatably disposed at a lower side of the cover to guide the paper discharged from the paper discharge hole downward.

19. The apparatus according to claim 10, further comprising:
a plurality of guide ribs protruding from a lower surface of the cover and configured to extend lengthwise in a movement direction of the paper discharged through the paper discharge hole.

20. The apparatus according to claim 10, wherein the cover is rotatably coupled, at one end thereof, to the housing, to open or close the upper side of the fixing unit.

21. An image forming device, comprising:
a fixing unit to fix developer to a recording medium;
a housing to support a fixing unit, and including a paper loading portion to form a recess and a paper discharge hole to discharge the recording medium after the developer is fixed thereon; and
a cover to removable cover a portion of the paper loading portion adjacent to the paper discharge hole.

22. The image forming device according to claim 21, further comprising:
one or more guide ribs disposed at a lower surface of the cover to prevent the recording medium discharged through the paper discharge hole from direct contact with a lower surface of the cover.

23. The image forming device according to claim 21, wherein the loading portion comprises:
a slope to support recording media.
